(19) United States
(12) Patent Application Publication
(10) Pub. No.: US 2011/0078747 A1
(43) Pub. Date: Mar. 31, 2011

(54) SYSTEMS AND METHODS FOR DISPLAYING A BLOCKING OVERLAY IN A VIDEO

(75) Inventor: David D. Chung, Santa Clara, CA (US)

(73) Assignee: ROVI TECHNOLOGIES CORPORATION, Santa Clara, CA (US)

(21) Appl. No.: 12/571,222

(22) Filed: Sep. 30, 2009

(51) Int. Cl. H04N 5/445; A63F 13/00; A63F 9/24

(52) U.S. Cl. 725/61; 463/30; 463/42

(57) ABSTRACT

An overlay application provides users with opportunities to block or cover portions of the display area by displaying an overlay. The overlay application may be used to implement an interactive poker game. An overlay may be displayed to block or cover players' cards on the display screen during e.g., a poker tournament, allowing the viewer to actively participate in the poker game. The overlay may be controlled by a content provider or may be user controlled.

### BACKGROUND OF THE INVENTION

This invention relates to displaying video, and more particularly, to interactively displaying an overlay that blocks or covers a portion of the display area while displaying the video.

An “enhanced” program may include a display with the video portion of the program in a picture-in-picture (PIP) window and program related information (PRI) in the remaining portion of the display area, or vice versa. Alternatively, the PRI may be displayed as an overlay on top of the video portion of the program.

PRI improves viewer experience by providing viewers the opportunity to interact with the programming, and captures viewers' attention for a longer period of time. Examples of PRI include cast members' biographies, trivia about the show, information relating to the particular episode or scene, and closeups of information that cannot be readily seen or is hidden in the video portion of the program (e.g., cards during a poker tournament). Some of the PRI may be time dependent on the program. For example, the PRI may change to correspond to a particular scene or frame of the television program.

However, in certain situations, it may not be desirable to viewers to view the PRI. For example, while viewing a poker tournament, viewers may not wish to see a close up of the players cards because they may want to try to predict what cards each player has. Additionally, even when a video does not contain PRI, viewers may not wish to view certain portions of the display area. For example, viewers may want to block a news ticker typically displayed on the bottom of the display area.

### SUMMARY OF THE INVENTION

In view of the foregoing, systems and methods that allow viewers to cover or block certain portions of the display area are provided.

In one suitable approach, PRI may be embedded in a television signal for display on a viewer's television equipment at the same time as the television program. For example, PRI may be embedded in the vertical blanking interval (VBI) of a television signal. Additionally, the PRI may be contained in one or more Internet sites, the addresses for which may be embedded in the television signal. The Internet site addresses may also be transmitted synchronously with, but separate from the video portion, e.g., via an interface device such as a telephone or cable modem. This PRI may be any textual or graphic information associated with the current program. The PRI may consist of a textual display of a World Wide Web (WWW) or other Internet site address to which the viewer can choose to link to through a connection with an Internet Service Provider. The PRI may also be contained in one or more Web pages, the addresses of which may be inserted into the television signal (e.g., in the VBI) and may be automatically retrieved by the user's equipment and displayed on the display screen.

In some embodiments, an overlay application (e.g., a widget) encoded using the ETV Binary Interchange Format (EBIF) may run on user's equipment (e.g., a set-top box), and automatically generate and display a blocking overlay which covers or blocks the PRI. The overlay application may also be encoded as a OpenCable Application Platform (OCAP) widget. One example of an OCAP widget is a Tru2way™ widget. Alternatively, the overlay application may be configured to run on a television e.g., encoded as a Yahoo! Connected TV widget.

The overlay application may be configured to automatically display and/or remove the blocking overlay, for example, based on a type of program, scene, frame, at a particular time, etc. Alternatively, the overlay application may display and/or remove the blocking overlay based at least in part on user input (e.g., a press of a button on a remote control).

In some embodiments, the overlay application may be configured to selectively block or cover any portion of the content being displayed. In other words, the overlay application may be used to block or cover any portion of the content being displayed even in the absence of PRI. For example, a viewer watching a sporting event such as a baseball game may not want to see the score being displayed. The viewer may press a button on a remote control to activate the overlay application which will display a blocking overlay that blocks or covers the score. The viewer may also be able to resize and move or position the overlay to any desirable area.

Additionally, the overlay application may display or remove the overlay automatically based on, for example, a particular time, a type of program, user profile, etc. For example, the overlay application may be configured to always display the overlay to block the score for every sporting event, or the overlay application may be configured to always display the overlay to block the bottom left corner of the display area when a particular viewer's profile is active.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative user equipment device in accordance with an embodiment of the invention;

FIG. 2 shows a simplified diagram of an illustrative interactive media system in accordance with an embodiment of the invention;

FIG. 3 is an exemplary screen of an enhanced program, in accordance with an embodiment of the present invention;

FIG. 4 is the exemplary screen of FIG. 3 at a later time in accordance with an embodiment of the present invention;

FIG. 5 is the exemplary screen of FIG. 4 with a blocking overlay in accordance with an embodiment of the present invention;

FIG. 6 is a flowchart of illustrative steps involved in displaying a blocking overlay to block or cover PRI in accordance with an embodiment of the present invention; and

FIG. 7 a flowchart of illustrative steps involved in displaying a blocking overlay in the absence of PRI in accordance with an embodiment of the present invention.

### DETAILED DESCRIPTION

The amount of media available to users in any given media delivery system can be substantial.

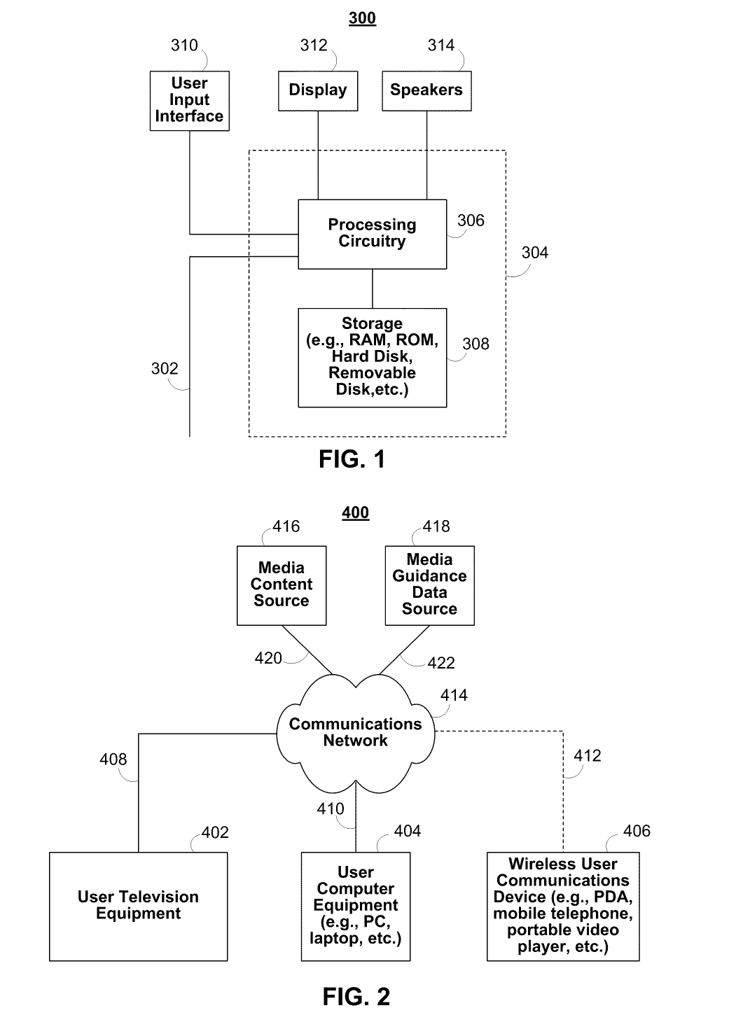

Users may access media content from one or more of their user equipment devices. FIG. 1 shows a generalized embodiment of illustrative user equipment device 300. More specific implementations of user equipment devices are discussed below in connection with FIG. 2. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 1 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for applications such as a media guidance application stored in memory (i.e., storage 308) or an overlay application in accordance with an exemplary embodiment of the present invention. In client-server based embodiments, control circuitry 304 may include communications circuitry suitable for communicating with a media content server or a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 2). In addition, communications circuitry may include circuitry that enables peer-to-peer communication of user equipment devices, or communication of user equipment devices in locations remote from each other.

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media and data described herein, including program information, guidance application settings, user preferences or profile information, or other data used in operating the guidance application and other applications (e.g., an overlay application) running on user television equipment 402. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data, PRI and other data used by applications (e.g., an overlay application) running on user television equipment 402. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

An overlay application, in accordance with an exemplary embodiment, which generates and displays an overlay that blocks or covers at least a portion of display 312 may be implemented using any suitable architecture. For example, it may be a stand-alone application wholly implemented on user equipment device 300. In such an approach, instructions of the overlay application are stored locally, and data for use by the overlay application is downloaded on a periodic basis (e.g., from the VBI of a television channel, from an out-of-band feed, or using another suitable approach). In another embodiment, the overlay application is a client-server based application. Data for use by a thick or thin client implemented on user equipment device 300 is retrieved on-demand by issuing requests to a server remote to the user equipment device 300. In one example of a client-server based overlay application, control circuitry 304 runs a web browser that interprets web pages provided by a remote server.

In yet other embodiments, the overlay application is downloaded and interpreted or otherwise run by an interpreter or virtual machine (run by control circuitry 304). In some embodiments, the overlay application may be encoded in the ETV Binary Interchange Format (EBIF), received by control circuitry 304 as part of a suitable feed, and interpreted by a user agent running on control circuitry 304. For example, the overlay application may be a EBIF widget.

In other embodiments, the overlay application may also be encoded as an OpenCable Application Platform (OCAP) widget. One example of an OCAP widget is a Tru2way™ widget. Alternatively, the overlay application may be configured to run on a television e.g., encoded as a Yahoo! Connected TV widget

In other embodiments, the overlay application may be defined by a series of JAVA-based files that are received and run by a local virtual machine or other suitable middleware executed by control circuitry 304. In some of such embodiments (e.g., those employing MPEG-2 or other digital media encoding schemes), the overlay application may be, for example, encoded and transmitted in an MPEG-2 object carousel with the MPEG audio and video packets of a program.

User equipment device 300 of FIG. 1 can be implemented in system 400 of FIG. 2 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 1 and, as a result, include flexibility with respect to the type of media content available on the device. For example, user television equipment 402 may be Internet-enabled allowing for access to Internet content, while user computer equipment 404 may include a tuner allowing for access to television programming.

In system 400, there may be more than one of each type of user equipment device but only one of each is shown in FIG. 2 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 2 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 2 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 2 to avoid overcomplicating the drawing. In addition, there may be more than one of each of media content source 416 and media guidance data source 418, but only one of each is shown in FIG. 2 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety. Media content source 416 may also provide trigger data (described in further detail below) to applications (e.g., an overlay application) and/or a user agent running on user television equipment 402.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance and trigger data to applications running on user equipment 402 e.g., an overlay application in accordance with an exemplary embodiment of the present invention. The present invention may be applied in any one or a subset of these approaches, or in a system employing other approaches for delivering media and providing media guidance and data.

Enhanced programs incorporate program-related information (PRI) comprising of text and/or graphics which may be displayed simultaneously with the regular video portion of the program in an enhancement mode. For example, the enhancement mode of one type of enhanced program consists of a display with the video portion of the program in a picture-in-picture (PIP) window and textual information and/or graphics, also referred to as the “enhancements,” or PRI in the remaining portion of the display area. Alternatively, PRI may be displayed in the PIP window or in any other section of the display area and the video portion may be displayed in the remaining area. In some embodiments, the PRI may be displayed as a graphical and/or textual overlay on top of the video.

The PRI may be inserted into the television signal (e.g., in the VBI) and transmitted simultaneously with the video signal. The PRI may also be transmitted synchronously with, but separate from the video portion, e.g., via an interface device such as a telephone or cable modem.

The PRI may also be contained in one or more Internet sites, the addresses for which may be embedded in the television signal. The Internet site addresses may also be transmitted synchronously with, but separate from the video portion, e.g., via an interface device such as a telephone or cable modem. The addresses may also be inserted into the VBI, and automatically retrieved and displayed by user television equipment 402 and/or user computer equipment 404.

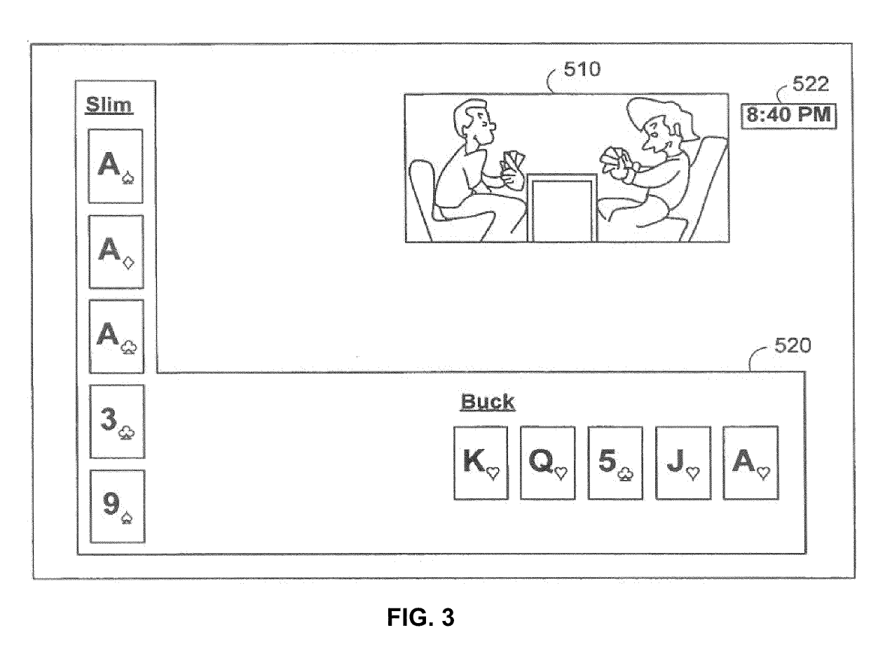

An exemplary layout of a display screen is shown in FIG. 3. The display includes a video portion 510 in a PIP window depicting a scene in which two characters are playing poker, and an enhancement or PRI portion 520. The PRI portion includes a closeup showing each player's hand at that particular time, which is shown as 8:40 PM on clock 522.

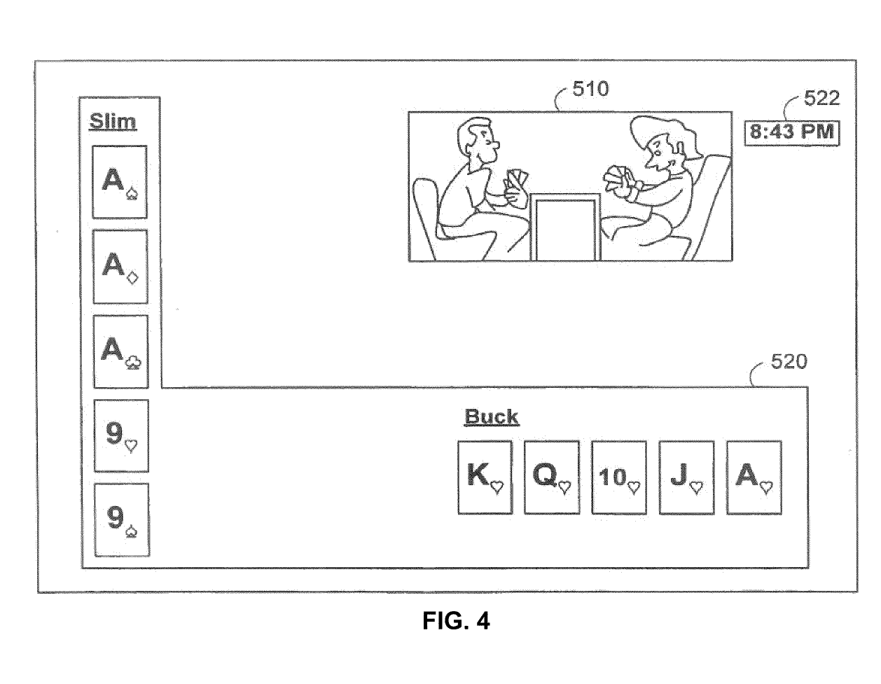

Some PRI may be time dependent on the program. For example, the PRI may change to correspond to a particular scene or frame of the program, such as in the exemplary screen of the enhanced program shown in FIG. 4.

FIG. 4 shows a later frame at 8:43 PM, according to clock 522, of the same scene shown in FIG. 3. The players have exchanged cards and their new card hands are shown in PRI portion 520.

However, certain viewers may not wish to view the PRI. For example, while viewing the program shown in FIGS. 3 and 4, certain viewers may not wish to see a close up of the players cards because they may want to try to predict what cards each player has. Not being able to view the players' cards may add a level of suspense to the program, and capture the viewers' attention for a longer period of time. In some embodiments, viewers simply may not wish to view a certain portion of the display area even if the program does not contain PRI. For example, some viewers may wish to block out the news ticker typically displayed in the bottom portion of the display area.

In accordance with an exemplary embodiment, an overlay application (e.g., a widget) encoded, for example, using the ETV Binary Interchange Format (EBIF), or as an OCAP widget, may be configured to run on user television equipment 402 (e.g., a set-top box). Alternatively, the overlay application may be configured to run on a television e.g., encoded as a Yahoo! Connected TV widget. The overlay application may automatically, or upon user command, display a blocking overlay which covers or blocks the PRI. For example, the overlay application may “listen” for a trigger to determine when to display or remove the blocking overlay. The trigger may be inserted by the content provider (e.g., media content source 416) into a packet identifier (PID) within an MPEG transport stream. The trigger may correspond to a particular type of program, a particular scene, etc. Alternatively, the trigger(s) may be stored locally on user television equipment 402 (e.g., a set-top box), and the overlay application may access the local storage device on the set-top box to retrieve the trigger(s). The trigger(s) stored in local storage on user television equipment 402 may have been previously received from media content source 416 (FIG. 2). In some embodiments, the trigger(s) may be retrieved by user television equipment 402 (FIG. 2) via the Internet from, for example, a server (not shown) at media content source 416 (FIG. 2).

The trigger may be a marker that alerts the overlay application of the existence of PRI. The overlay application may, based at least in part on the trigger, display the blocking overlay to block or cover the PRI. The overlay application may determine the appropriate size and position of the blocking overlay to cover the PRI without interrupting the video. Alternatively, the trigger may contain information indicating the time and duration to display the blocking overlay, and the size and position of the blocking overlay. The overlay application may display the blocking overlay based on this information. For example, the trigger may include a time indicating when the overlay should be displayed, a channel number for which the overlay should be displayed, a duration indicating how long the overlay should be displayed, and coordinate information indicating the display area that should be blocked or covered.

In some embodiments where the program does not have any associated PRI, the trigger may include a marker which alerts the overlay application to enable the blocking overlay. Once enabled, the user may set the size and position of the blocking overlay to block any desirable portion of the display area. Additionally, the user may dictate when to remove the blocking overlay.

In some embodiments, where the program does or does not have any associated PRI, the overlay application may be user controlled. For example, the overlay application may be enabled and disabled by user command (e.g., press of a button on a remote control) without the need for triggers. Once activated, the user may arrange the size, position, transparency, etc of the overlay, and may remove the overlay at any time.

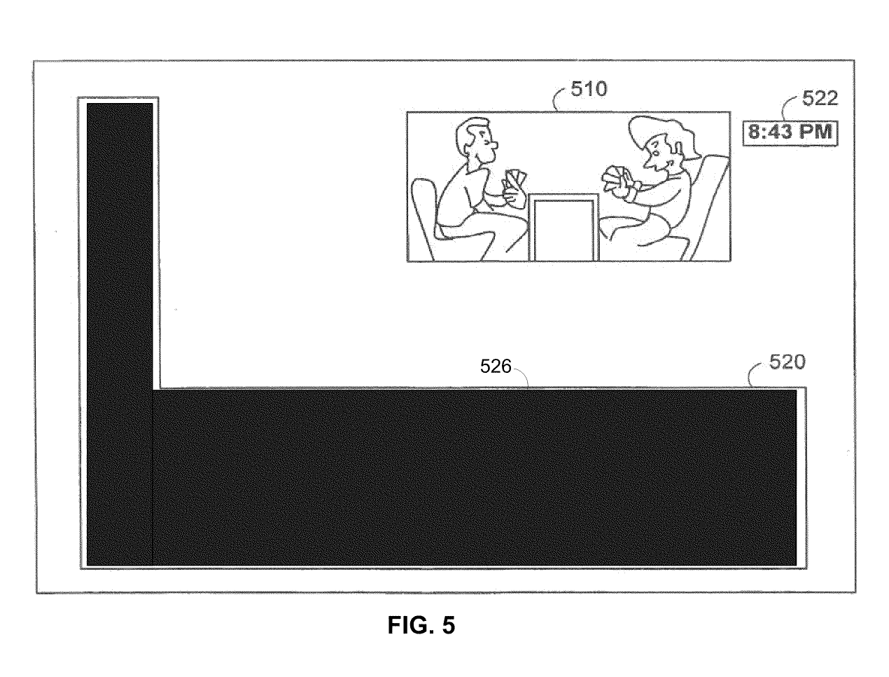

FIG. 5 shows blocking overlay 526 displayed by the overlay application to cover PRI portion 516. The overlay application may be configured to automatically display and/or remove the blocking overlay 526, for example, at a particular time, based on a particular program, scene or frame.

Alternatively, or in addition, the overlay application may display and/or remove the blocking overlay based at least in part on user input. For example, the user may press a button on a remote control in response to an on-screen prompt. The on-screen prompt may be generated in response to a trigger received from a content provider (e.g., media content source 416) or retrieved from local storage. In some embodiments, the overlay application may be configured to display and/or remove the blocking overlay solely in response to user input (e.g., without a trigger).

In some embodiments, the overlay application may be configured to display an overlay to selectively block or cover any portion of the display area. In other words, the overlay application may be configured to block or cover any portion of the display area even if the program does not contain PRI. For example, a viewer watching a sporting event such as a baseball game may not want to see the score being displayed. The viewer may press a button on a remote control to activate the overlay application which will display a blocking overlay. Once displayed, the viewer may resize and move or position the blocking overlay to any desirable area (e.g., the area that displays the score). The viewer may press the button again to remove the overlay. Additionally, the viewer may be able to customize the color and/or transparency of the overlay.

Alternatively, the overlay application may automatically display or remove the overlay based on, for example, a particular time, a type of program, user profile, etc. For example, the overlay application may be configured to display the overlay to block the score for every sporting event, or the application may be configured to always display the overlay to block the bottom left corner of the display area when a particular viewer's profile is active.

In accordance with an exemplary embodiment, the overlay application may be used to block a news, sports or similar ticker. For example, often times when a sporting event is re-broadcasted (i.e., at a time other than the live broadcast), a news or similar ticker may include, for example, scores or similar information which may ruin the viewing experience of a viewer who may be viewing the sporting event for the first time. Media content source 416 (FIG. 2) may thus transmit one or more triggers to user television equipment 402 (FIG. 2) to activate the overlay application and to instruct the overlay application to display a blocking overlay in the area of the display screen which displays the ticker (typically along the bottom of the display area). Similarly, media content source 416 (FIG. 2) may transmit one or more triggers to user television equipment 402 (FIG. 2) to remove the blocking overlay when the ticker comes to an end.

Alternatively, the blocking overlay may be completely user controlled. For example, the viewer, as opposed to triggers, may dictate when, where and how long to display the blocking overlay.

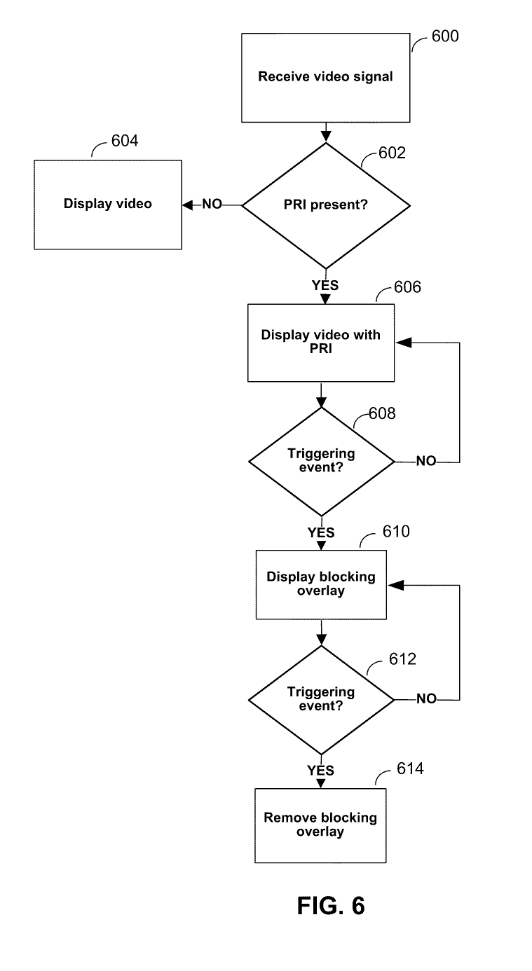

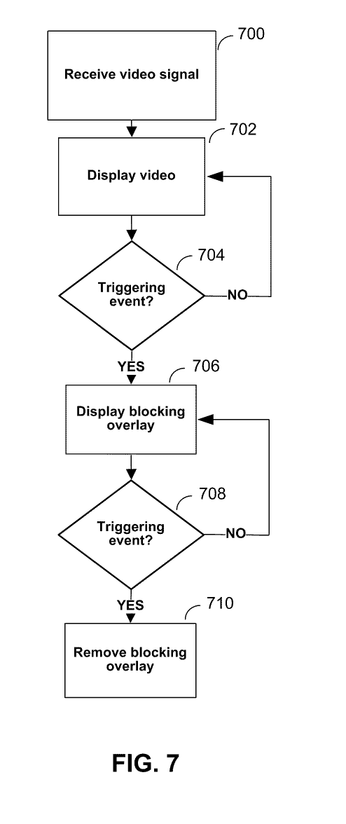

FIGS. 6 and 7 are flowcharts of illustrative steps involved in displaying a blocking overlay which covers or blocks at least a portion of the display area.

FIG. 6 is a flowchart of illustrative steps involved in displaying a blocking overlay to block or cover PRI. A video signal is received by user television equipment 402 (FIG. 2) in step 600. In step 602, user television equipment 402 (FIG. 2) may determine if PRI is present in the video signal. If there is no PRI associated with the video signal, user television equipment 402 (FIG. 2) may display the video in step 604 on display screen 312 (FIG. 1). However, if there is PRI associated with the video signal, user television equipment 402 (FIG. 2) may display the video along with the PRI in step 606 on display screen 312 (FIG. 1). The PRI may be displayed in a PIP window and the video portion may be displayed in the remaining display area. Alternatively, the PRI may be displayed in any other portion of the display area, and the video may be displayed in the remaining portion. If it is determined in step 608 that there is no triggering event, user television equipment 402 (FIG. 2) may continue to display the video signal. However, if it is determined in step 608 that there is a triggering event, an overlay application may display a blocking overlay to cover the PRI in step 610. A triggering event may be, for example, user input (e.g., pressing a button on a remote control), a type of program, a particular scene, a time of day, a particular user's profile being active, etc. The triggering event may be determined based on a trigger which may be received from media content source 416 (FIG. 2) in a PID within a MPEG transport stream. Alternatively, the trigger may be retrieved from local storage 308 (FIG. 1) on user television equipment 402 (e.g., a set-top box). The triggers stored in local storage 308 (FIG. 1) may have been previously received from media content source 416 (FIG. 2). The trigger may include data representative of a time indicating when the overlay should be displayed, a channel number for which the overlay should be displayed, a duration indicating how long the overlay should be displayed, and coordinate information indicating the display area that should be blocked or covered. In some embodiments, the overlay application may communicate with the media guidance application to determine which, or if any, user's profile is active. The media guidance application may also provide information such as, the type of program being displayed, the channel being viewed, etc. The overlay application may determine, based at least on the information received from the media guidance application, whether to display the blocking overlay for a particular user.

In accordance with an exemplary embodiment, the overlay application may be configured to display the blocking overlay to cover the PRI when the user presses a button on a remote control. Additionally, the overlay application may be configured to display the blocking overlay in particular types of programs. For example, the overlay application may be configured to display the blocking overlay in all programs involving card games (e.g., poker). Moreover, the overlay application may display the overlay in certain scenes. For example, in the program shown in FIGS. 3-5, the overlay application may automatically display the blocking overlay during the poker scene and remove the overlay once the scene is over. Additionally, the overlay application may be configured to display the blocking overlay to cover the PRI for all times when a particular user's profile is active.

The overlay application may automatically configure the blocking overlay to be of a shape or size large enough to cover the PRI without interrupting or covering any of the video portion. The blocking overlay may be opaque or semi transparent. Additionally, the overlay application may position the blocking overlay in any portion of the display area where PRI may be displayed.

If it is determined in step 612 that there is no triggering event, the overlay application may continue to display the blocking overlay. However, if it is determined that there is a triggering event, the overlay application may remove the blocking overlay in step 614. As previously described, the triggering event may be, for example, user input (e.g., pressing a button on a remote control), a type of program, a particular scene, a time of day, a particular user's profile being active, etc. The triggering events may be determined based on triggers which may be received from media content source 416 (FIG. 2) or retrieved from local storage 308 (FIG. 1). The triggers stored in local storage 308 (FIG. 1) may have been previously received from media content source 416 (FIG. 2). In some embodiments, triggering events may be determined based on information received from the media guidance application indicating which user's profile is active. The media guidance application may also provide information such as, the type of program being displayed, the channel being viewed, etc. The overlay application may determine, based at least on the information received from the media guidance application, whether to remove the blocking overlay for a particular user.

In accordance with an exemplary embodiment, the overlay application may be used to facilitate an interactive program or game. One example of an interactive game or program is a poker game. The overlay application may allow viewers to play along with players on a poker program or allow viewers to try to guess the players' cards. User television equipment 402 (FIG. 2) may receive a broadcast signal of a poker program (e.g., a poker tournament) from e.g., media content source 416 (FIG. 2). The signal may include PRI information corresponding to the poker program. User television equipment 402 (FIG. 2) may display the video portion of the program and the PRI portion of the program for example, as shown in FIG. 3. The PRI portion may include the cards held by the players in the poker tournament.

Media content source 416 (FIG. 2)may transmit one or more triggers to user television equipment 402 (FIG. 2) to activate the overlay application and to instruct the overlay application to display a blocking overlay in the area of the display screen which displays the players' cards. The one or more triggers may also include information instructing the overlay application about the size of the blocking overlay, the transparency of the blocking overlay etc. The one or more triggers may be transmitted by media content source 416 (FIG. 2) to correspond to a particular event (e.g., dealing of a new hand) in the poker tournament. Likewise, media content source 416 (FIG. 2) may transmit one or more triggers instructing the overlay application to remove the blocking overlay. For example, when the round is over, media content source 416 (FIG. 2) may transmit one or more triggers to remove the blocking overlay to allow the viewer to see the players' cards. Blocking the players cards allows viewers to participate in the program and captures the viewers attention for a longer period.

Alternatively, the blocking overlay may be completely user controlled. For example, the viewer, as opposed to triggers, may dictate when, where and how long to display the blocking overlay. A poker tournament is but one example of the use of the overlay application. The overlay application may be implemented for any type of program or show.

FIG. 7 is a flowchart of illustrative steps involved in displaying a blocking overlay to block or cover a portion of the display area in the absence of PRI in the video signal. A video signal is received by user television equipment 402 (FIG. 2) in step 700, and user television equipment 402 (FIG. 2) displays the video signal on display screen 312 (FIG. 1) in step 702. If it is determined in step 704 that there is no triggering event, user television equipment 402 (FIG. 2) may continue to display the video signal on display screen 312 (FIG. 1). However, if it is determined in step 704 that there is a triggering event, an overlay application may display a blocking overlay in step 706. A triggering event may be, for example, user input (e.g., pressing a button on a remote control), a type of program, a particular scene, a time of day, a particular user's profile being active, etc. For example, the overlay application may be configured to display a blocking overlay in the upper left corner of the screen (typically used to display the score) for all baseball games. Additionally, the overlay application may be configured to display the blocking overlay along the bottom border region of display screen 312 (FIG. 1) to block a news ticker for all programs before 10 AM.

In accordance with an exemplary embodiment, triggering events may be determined based on triggers which may be received from media content source 416 (FIG. 2) or retrieved from local storage 312 (FIG. 1). The triggers stored in local storage 308 (FIG. 1) may have been previously received from media content source 416 (FIG. 2). In some embodiments, triggering events may be determined based on information received from the media guidance application indicating which user's profile is active. The media guidance application may also provide information such as, the type of program being displayed, the channel being viewed, etc.

In accordance with an exemplary embodiment, the user may use the blocking overlay to block or cover any desirable portion of the display area. The blocking overlay may be customizable by the user. For example, the user may customize the size, shape, location, and transparency of the blocking overlay. If it is determined in step 708 that there is no triggering event, the overlay application may continue to display the blocking overlay. However, if it is determined that there is a triggering event, the overlay application may remove the blocking overlay in step 710. As previously described, the triggering event may be, for example, user input (e.g., pressing a button on a remote control), a type of program, a particular scene, a time of day, a particular user's profile being active, etc.

It will be appreciated that while the discussion of media content has focused on video content, the principles of displaying a blocking overlay can be applied to other types of media content, such as, images, etc.

The foregoing is merely illustrative of the principles of this invention and various modifications can be made by those skilled in the art without departing from the scope and spirit of the invention. The above described embodiments of the present invention are presented for purposes of illustration and not of limitation, and the present invention is limited only by the claims which follow.

What is claimed is:

1. A method for facilitating an interactive television program, the method comprising:
receiving a television signal of a poker tournament;
displaying video of the poker tournament in a first predetermined location on a display screen;
displaying cards of players participating in the poker tournament in a second predetermined location on the display screen;
displaying, at a first predetermined event, an overlay in the second predetermined location; and
removing the overlay at a second predetermined event.

2. The method of claim 1, wherein receiving the television signal comprises receiving the television signal with embedded data representative of program related information (PRI).

3. The method of claim 2, wherein the program related information includes data representative of the cards.

4. The method of claim 1, wherein the overlay substantially blocks or covers the cards displayed in the second predetermined location.

5. The method of claim 1, wherein the first and second predetermined events are determined based at least in part on one or more triggers received from a content provider.

6. The method of claim 5, wherein the one or more triggers is received in an MPEG transport stream.

7. The method of claim 5, wherein the one or more triggers is received via the Internet.

8. The method of claim 1, wherein the first and second predetermined events are determined based at least in part on one or more triggers retrieved from local storage.

9. The method of claim 1, wherein the first and second predetermined events are determined based at least in part on user input.

10. The method of claim 2, wherein the data representative of the program related information (PRI) is received in a vertical blanking interval of the television signal.

11. A system for facilitating an interactive television program, comprising:
user television equipment comprising a display screen; and
a content provider;
wherein the user television equipment is configured to:
receive a television signal of a poker tournament;
display video of the poker tournament in a first predetermined location on a display screen;
display cards of players participating in the poker tournament in a second predetermined location on the display screen;
display, at a first predetermined event, an overlay in the second predetermined location; and
remove the overlay at a second predetermined event.

12. The system of claim 11, wherein receiving the television signal comprises receiving the television signal with embedded data representative of program related information (PRI).

13. The system of claim 12, wherein the program related information includes data representative of the cards.

14. The system of claim 11, wherein the overlay substantially blocks or covers the cards displayed in the second predetermined location.

15. The system of claim 11, wherein the first and second predetermined events are determined based at least in part on one or more triggers received from the content provider.

16. The system of claim 15, wherein the one or more triggers is received in an MPEG transport stream.

17. The system of claim 11, wherein the first and second predetermined events are determined based at least in part on one or more triggers retrieved from local storage.

18. The system of claim 15, wherein the one or more triggers is received via the Internet.

19. The system of claim 11, wherein the first and second predetermined events are determined based at least in part on user input.

20. The system of claim 12, wherein the data representative of the program related information (PRI) is received in a vertical blanking interval of the television signal.

21. The system of claim 11, wherein receiving the television signal comprises receiving the television signal with embedded data representative of an address for an Internet site including program related information (PRI), the program related information including data representative of the cards.
